(19) United States
(12) Patent Application Publication
(10) Pub. No.: US 2018/0363777 A1
(43) Pub. Date: Dec. 20, 2018

(54) A METHOD OF MAKING A SYNCHRONOUS SHIFT BETWEEN TWO MODES OF A MUTLI-MODE CONTINOUSLY VARIABLE TRANSMISSION

(71) Applicant: DANA LIMITED, MAUMEE, OH (US)

(72) Inventor: GORDON MCINDOE, VOLENTE, TX (US)

(73) Assignee: DANA LIMITED, MAUMEE, OH (US)

(21) Appl. No.: 15/736,924

(22) PCT Filed: Jun. 17, 2016
(86) PCT No.: PCT/US16/38064

§ 371 Date: Dec. 15, 2017

Related U.S. Application Data
(60) Provisional application No. 62/181,588, filed on Jun. 18, 2015.

(51) Int. Cl. F16H 61/70; F16H 37/08; F16H 15/50; F16H 61/04; F16H 61/664

(52) U.S. Cl. CPC F16H 61/702; F16H 37/086; F16H 15/503; F16H 2059/704; F16H 61/664; F16H 2037/0886; F16H 2306/48; F16H 61/0403

(57) ABSTRACT

An electronic controller is described herein that enables electronic control over a variable ratio transmission comprising a continuously variable ratio portion, such as a Continuously Variable Transmission (CVT), Infinitely Variable Transmission (IVT), or variator. The electronic controller is configured to receive input signals indicative of parameters associated with a prime mover or an engine coupled to the transmission. The parameters include throttle position sensor values, vehicle speed, gear selector position, user selectable mode configurations, and the like, or some combination thereof. The electronic controller also receives one or more control inputs. The electronic controller determines an active range and an active variator mode based on the input signals and control inputs. The electronic controller controls a final drive ratio of the variable ratio transmission by controlling one or more electronic actuators and/or solenoids that control the ratios of one or more portions of the variable ratio transmission.

### CROSS-REFERENCE

The present application claims the benefit of U.S. Provisional Application No. 62/181,588, filed Jun. 18, 2015, which is incorporated herein by reference in its entirety.

### BACKGROUND OF THE INVENTION

Continuously variable transmissions (CVT) and transmissions that are substantially continuously variable are increasingly gaining acceptance in various applications. The process of controlling the ratio provided by the CVT is complicated by the continuously variable or minute gradations in ratio presented by the CVT. Furthermore, the range of ratios that may be implemented in a CVT may not be sufficient for some applications.

### SUMMARY OF THE INVENTION

A transmission may implement a combination of a CVT with one or more additional CVT stages, one or more fixed ratio range splitters, or some combination thereof in order to extend the range of available ratios. The combination of a CVT with one or more additional stages further complicates the ratio control process, as the transmission may have multiple configurations that achieve the same final drive ratio.

The different transmission configurations are optionally configured to, for example, multiply input torque across the different transmission stages in different manners to achieve the same final drive ratio. However, some configurations provide more flexibility or better efficiency than other configurations providing the same final drive ratio.

The criteria for optimizing transmission control may be different for different applications of the same transmission. For example, the criteria for optimizing control of a transmission for fuel efficiency may differ based on the type of prime mover applying input torque to the transmission. Furthermore, for a given transmission and prime mover pair, the criteria for optimizing control of the transmission may differ depending on whether fuel efficiency or performance is being optimized.

Provided herein is a control system for a multiple-mode continuously variable transmission comprising a ball planetary variator operably coupled to multiple-mode gearing, the control system comprising: a plurality of sensors coupled to the ball planetary variator and the multiple-mode gearing, the sensors configured to provide a plurality of electronic signals; a variator position control module configured to command a position of the ball planetary variator; a clutch control module configured to control an interfacing clutch, wherein the interfacing clutch is operably coupled to the ball planetary variator and the multiple-mode gearing; a variator ratio control module configured to command a ratio of the ball planetary variator; a mode-shift manager module configured to be in communication with the clutch control module, the variator position control module, and the variator ratio control module; wherein the mode-shift manager module is configured to coordinate a torque command, a variator ratio command, a variator position command, and a clutch command based at least in part on a synchronous shift point. In some embodiments of the control system, the variator ratio control module, the variator position control module, the clutch control module and the mode-shift manager module are configured within a transmission control module. In some embodiments of the control system, the mode-shift manager module is configured to command a zero torque value based at least in part on a comparison of the variator position to the synchronous shift point. In some embodiments of the control system, the mode-shift manager module comprises at least one configurable table stored in memory, the configurable table containing a plurality of torque values corresponding to a variator position at a synchronous shift point. In some embodiments of the control system, the mode-shift manager module is configured to communicate with the clutch control module, and the mode-shift manager is adapted to send a command for a shift event based at least in part on a comparison to a variator position corresponding to the synchronous shift point. In some embodiments of the control system, the mode-shift manager module is configured coordinate a shift from an initial mode of operation to a next mode of operation, and/or vice versa. In some embodiments of the control system, the clutch control module is configured to command position of the interfacing clutch. In some embodiments of the control system, the variator ratio control module is configured to command a desired speed ratio for the variator. In some embodiments of the control system, the variator position control module is configured to command a desired carrier position for the variator. In some embodiments of the control system, an input processing module is configured to read a number of sensors from the multiple-mode continuously variable transmission, an engine, and/or a vehicle. In some embodiments of the control system, the input processing module is configured to read the plurality of signals from the plurality of sensors, the plurality of signals comprising; temperature sensors, pressure sensors, speed sensors, and digital sensors comprising range indicators, pressure switches and CAN signals. In some embodiments of the control system, an output processing module is configured to convert the values for commanded variables generated in the transmission control module into voltage signals that are sent to corresponding actuators and/or solenoids in the transmission.

Provided herein is a method of operating a multiple-mode continuously variable transmission comprising a variator, a multiple-mode gearing, and an interfacing clutch, the method comprising the steps of: receiving a plurality of input signals indicative of a variator position, a variator ratio, and a transmission operating torque; comparing a current variator ratio to a synchronous shift variator ratio corresponding to a synchronous shift point of the multiple-mode continuously variable transmission; commanding a zero input torque based at least in part on said comparison; commanding a shift of the interfacing clutch based at least in part on said comparison; and commanding a variator position based at last in part on said comparison.

Provided herein is a control system for a multiple mode continuously variable transmission having a ball planetary variator operably coupled to multiple-mode gearing, the control system comprising: a transmission control module configured to receive a plurality of electronic input signals; wherein the transmission control module is configured to determine a mode of operation from a plurality of control ranges based at least in part on the plurality of electronic input signals; and wherein the transmission control module comprises a variator ratio control module, a variator position control module, a clutch control module and a mode-shift manager module. In some embodiments of the control system, the variator position control module is configured to command a position of the carrier of the ball planetary variator; the clutch control module is configured to control an interfacing clutch, wherein the interfacing clutch is operably coupled to the ball planetary variator and the multiple-mode gearing; a variator ratio control module is configured to command a ratio of the ball planetary variator; and a mode-shift manager module is configured to be in communication with the clutch control module, the variator position control module, and the variator ratio control module; wherein the mode-shift manager module is configured to coordinate a torque command, a variator ratio command, a variator position command, and a clutch command based at least in part on a synchronous shift variator ratio.

Provided herein is a control system for a multiple mode continuously variable transmission having a ball planetary variator operably coupled to multiple-mode gearing, the control system comprising: a transmission control module comprising at least one processor configured to perform executable instructions, a memory, and instructions executable by the processor to configure the transmission control module to receive a plurality of electronic input signals and determine a mode of operation from a plurality of control ranges based at least in part on the plurality of electronic input signals. In some embodiments of the control system, a variator control module comprises a plurality of instructions executable by the processor to receive a desired speed ratio and determine an actuator command signal based at least in part on the mode of operation; and a variator position control module comprises a plurality of instructions executable by the processor to command a desired carrier position for the of the ball planetary variator; a clutch control module comprises a plurality of instructions executable by the processor to control an interfacing clutch, wherein the interfacing clutch is operably coupled to the ball planetary variator and the multiple-mode gearing; and a mode-shift manager module comprises a plurality of instructions executable by the processor to coordinate a torque command, a variator ratio command, a variator position command, and a clutch command based at least in part on a synchronous shift point. In some embodiments of the control system, a ratio shift schedule module comprises a plurality of instructions executable by the processor to receive signals such as a throttle position, a vehicle speed, and a user-selectable mode; a clutch control module comprising a plurality of instructions executable by the processor to receive and send electronic signals to solenoids within a multiple-mode gearing portion of the transmission; and a variator control module comprising a plurality of instructions executable by the processor to receive input signals comprises; current variator speed ratio; current variator actuator position; throttle position; prime mover or engine torque; and desired operating mode; wherein the variator control module is configured to determine an actuator command signal based at least in part on the mode of operation and a torque reversal module configured to receive a mode of operation, and determine a signal indicative of a torque reversal event based at least in part on the desired speed ratio and the actuator command signal. In some embodiments of the control system, the variator control module comprises: the torque reversal module comprising a plurality of instructions executable by the processor to determine the presence of a torque reversal event due to a shift in mode; a normal speed ratio command module comprising a plurality of instructions executable by the processor to configure the normal speed ratio command module to determine a target speed ratio command; and a torque reversal speed ratio command module comprising a plurality of instructions executable by the processor to configure the torque reversal speed ratio command module to determine the presence of a torque reversal event due to a shift in mode. In some embodiments of the control system, the variator control module further comprises: a position control module to control the variator based on actuator position alone at low or near zero speed conditions. In some embodiments of the control system, the variator control module further comprises: a position control module to control the variator based on actuator position during the synchronous mode shift.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a schematic diagram of a representative multiple-mode transmission having a continuously variable planetary, multiple-mode gearing, and at least one interfacing clutch.

FIG. 2 is a block diagram depicting a control system that can be implemented to control the transmission of FIG. 1.

FIG. 3 is a block diagram of a control algorithm that can be implemented in the control system of FIG. 2.

FIG. 4 is a block diagram of a control algorithm that can be implemented in the control system of FIG. 2.

FIG. 5 is a chart depicting a relationship between the position of the variator versus operating torque at a synchronous point.

FIG. 6 is a chart depicting relationships between transmission operating mode, variator ratio, variator position, and operating torque versus time during a shift in transmission operating mode.

### DETAILED DESCRIPTION OF THE INVENTION

An electronic controller is described herein that enables electronic control over a variable ratio transmission having a continuously variable ratio portion, such as a Continuously Variable Transmission (CVT), Infinitely Variable Transmission (IVT), or variator. The electronic controller is configured to receive input signals indicative of parameters associated with a prime mover or an engine coupled to the transmission. The parameters include throttle position sensor values, vehicle speed, gear selector position, user selectable mode configurations, and the like, or some combination thereof. The electronic controller also receives one or more control inputs. The electronic controller determines an active range and an active variator mode based on the input signals and control inputs. The electronic controller controls a final drive ratio of the variable ratio transmission by controlling one or more electronic actuators and/or solenoids that control the ratios of one or more portions of the variable ratio transmission.

The electronic controller described herein is described in the context of a continuous variable transmission, such as the continuous variable transmission of the type described in Patent Application Number PCT/US2014/41124, entitled “3-Mode Front Wheel Drive And Rear Wheel Drive Continuously Variable Planetary Transmission,” and U.S. Application Nos. 62/089,126 and 62/144,751, both entitled: “3-Mode Front Wheel Drive and Rear Wheel Drive Continuously Variable Planetary Transmission”, and U.S. Application No. 62/158,847, entitled “Control Method for Synchronous Shifting of Multi-Range Transmission Comprising a CVT Mechanism which Exhibits Creep Under Load”, assigned to the assignee of the present application and hereby incorporated by reference herein in their entirety. However, the electronic controller is not limited to controlling a particular type of transmission and is optionally configured to control any of several types of variable ratio transmissions.

As used here, the terms “operationally connected,” “operationally coupled”, “operationally linked”, “operably connected”, “operably coupled”, “operably linked,” and like terms, refer to a relationship (mechanical, linkage, coupling, etc.) between elements whereby operation of one element results in a corresponding, following, or simultaneous operation or actuation of a second element. It is noted that in using said terms to describe inventive embodiments, specific structures or mechanisms that link or couple the elements are typically described. However, unless otherwise specifically stated, when one of said terms is used, the term indicates that the actual linkage or coupling may take a variety of forms, which in certain instances will be readily apparent to a person of ordinary skill in the relevant technology.

For description purposes, the term “radial” is used here to indicate a direction or position that is perpendicular relative to a longitudinal axis of a transmission or variator. The term “axial” as used here refers to a direction or position along an axis that is parallel to a main or longitudinal axis of a transmission or variator. For clarity and conciseness, at times similar components labeled similarly (for example, bearing 1011A and bearing 1011B) will be referred to collectively by a single label (for example, bearing 1011).

It should be noted that reference herein to “traction” does not exclude applications where the dominant or exclusive mode of power transfer is through “friction.” Without attempting to establish a categorical difference between traction and friction drives here, generally these may be understood as different regimes of power transfer. Traction drives usually involve the transfer of power between two elements by shear forces in a thin fluid layer trapped between the elements. The fluids used in these applications usually exhibit traction coefficients greater than conventional mineral oils. The traction coefficient (μ) represents the maximum available traction forces which would be available at the interfaces of the contacting components and is a measure of the maximum available drive torque. Typically, friction drives generally relate to transferring power between two elements by frictional forces between the elements. For the purposes of this disclosure, it should be understood that the CVTs described here may operate in both tractive and frictional applications. For example, in the embodiment where a CVT is used for a bicycle application, the CVT operates at times as a friction drive and at other times as a traction drive, depending on the torque and speed conditions present during operation.

As used herein, “creep” or “slip” is the discrete local motion of a body relative to another and is exemplified by the relative velocities of rolling contact components such as the mechanism described herein. “Creep” is characterized by the slowing of the output because the transmitted force is stretching the fluid film in the direction of rolling. As used herein, the term “ratio droop” refers to the shift of the tilt angle of the ball axis of rotation (sometimes referred to as the ratio angle or gamma angle) due to a compliance of an associated control linkage in proportion to a control force that is in proportion to transmitted torque, wherein the compliance of the control linkage corresponds to a change in the skew angle of the ball axis of rotation. As used herein, the term “load droop” refers to any operating event that reduces the ratio of output speed to input speed as transmitted torque increases. In traction drives, the transfer of power from a driving element to a driven element via a traction interface requires creep. Usually, creep in the direction of power transfer, is referred to as “creep in the rolling direction.” Sometimes the driving and driven elements experience creep in a direction orthogonal to the power transfer direction, in such a case this component of creep is referred to as “transverse creep.”

For description purposes, the terms “prime mover”, “engine,” and like terms, are used herein to indicate a power source. Said power source may be fueled by energy sources comprising hydrocarbon, electrical, biomass, nuclear, solar, geothermal, hydraulic, pneumatic, and/or wind to name but a few. Although typically described in a vehicle or automotive application, one skilled in the art will recognize the broader applications for this technology and the use of alternative power sources for driving a transmission comprising this technology.

Provided herein is a control system for a multiple-mode continuously variable transmission comprising a ball planetary variator operably coupled to multiple-mode gearing, the control system comprising: a clutch control module configured to control an interfacing clutch, wherein the interfacing clutch is operably coupled to the ball planetary variator and the multiple-mode gearing; a variator position control module configured to command a position of the ball planetary variator; and a variator ratio control module configured to command a ratio of the ball planetary variator; a mode-shift manager module configured to be in communication with the clutch control module, the variator position control module, and the variator ratio control module; wherein the mode-shift manager module is configured to coordinate a torque command, a variator ratio command, a variator position command, and a clutch command based at least in part on a synchronous shift point.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor reads information from, and writes information to, the storage medium. In the alternative, the storage medium may be integral to the processor. The processor and the storage medium may reside in an ASIC. For example, in one embodiment, a controller for use of control of the IVT comprises a processor (not shown).

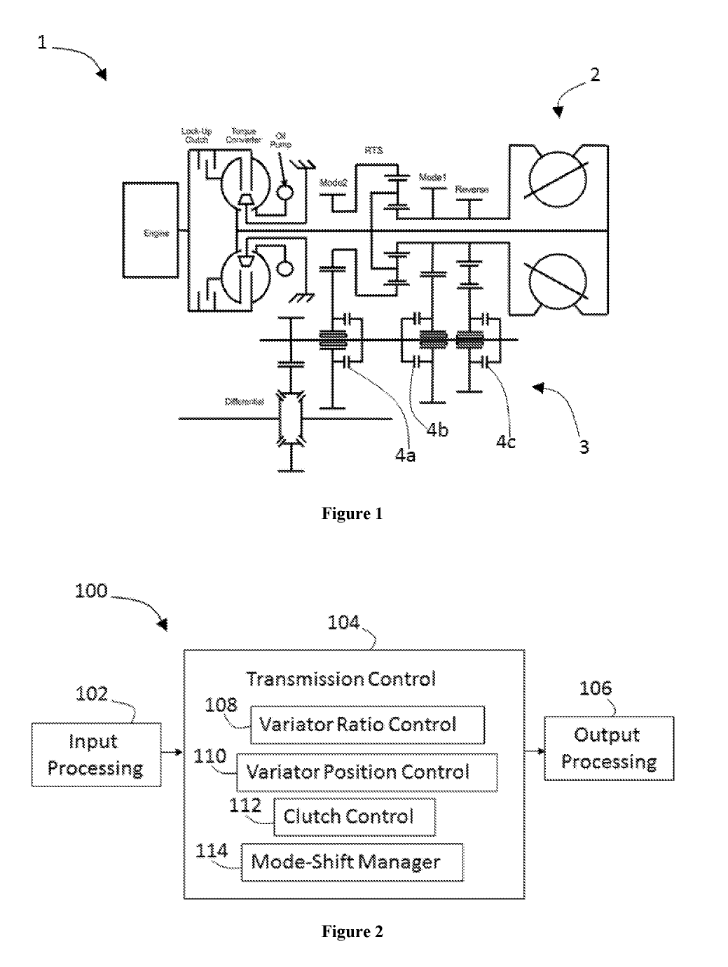

Referring now to FIG. 1, a transmission 1 is an illustrative example of a transmission having a continuously variable ratio portion, or variator 2, and a multiple-mode gearing portion 3. In one embodiment, the multiple-mode gearing portion 3 incorporates at least one interfacing clutch, or “dog” clutch 4. In some embodiments, the variator 2 is based on a ball type variators, also known as CVP, for continuously variable planetary. Basic concepts of a ball type Continuously Variable Transmissions are described in U.S. Pat. Nos. 8,469,856 and 8,870,711 incorporated herein by reference in their entirety. Such a CVT, adapted herein as described throughout this specification, comprises a number of balls (planets, spheres), two ring (disc) assemblies with a conical surface in contact with the balls, and an idler (sun) assembly. The balls are mounted on tiltable axles, themselves held in a carrier (stator, cage) assembly having a first carrier member operably coupled to a second carrier member. A position of the first carrier member with respect to the second carrier member is electronically controlled to thereby adjust the speed ratio of the variator.

As illustrated in FIG. 1, the transmission 1 is provided with a first interfacing clutch 4a, a second interfacing clutch 4b, and a third interfacing clutch 4c. In some embodiments, the first interfacing clutch 4a, the second interfacing clutch 4b, and the third interfacing clutch 4c are arranged along a parallel axis to the variator 2. During operation of the transmission 1, the second interfacing clutch 4b is selectively engaged in a position corresponding to a first mode of operation. The first interfacing clutch 4a is selectively e engaged in a position corresponding to a second mode of operation. Torque transmitted through the variator 2 during the transition between the first mode and the second mode reverses direction and consequently produces a change in the actual variator speed ratio. In some embodiments, the first mode of operation and the second mode of operation correspond to forward modes. In some embodiments, the third interfacing clutch 4c is selectively engaged in a position corresponding to a reverse mode of operation.

In some embodiments, the transmission 1 shifts from the first mode to the second mode when the speed of the off-going (or disengaging) clutch is nearly equal to the speed of the on-going (or engaging) clutch. This type of shift event is referred to as the synchronous shift point, sometimes referred to herein as a synchronous shift variator ratio.

One of skill in the art will also recognize that additional forward modes; i.e.: a third mode, a fourth mode, etc., may also be included in this configuration, provided the additional modes also engage at a synchronous shift point.

As a further explanation of the synchronous shift point, one of skill in the art would recognize that when using a dog clutch or interfacing clutch, oftentimes there is a slight back taper on the teeth to assure that when torque is transferred across the clutch, the taper draws the clutch into engagement to ensure that the clutch stays engaged. Because of this, the interfacing clutches are very difficult to disengage when transferring torque due to the force required to overcome the engagement force produced by the back taper. The control systems and methods described herein are configured to command a zero torque when operating at the synchronous ratio. This will allow for a shift that is fast and does not cause driveline disruptions (clunks, jerks, etc). Because the torque must reverse direction through the CVP when shifting from one mode to the next, it must pass through zero torque. The control system and method described herein positions the carrier of the variator in the correct position to give the transmission a synchronous ratio when operating torque reaches zero. The control system and method changes when the direction of torque change is different. The difference exists to assure that the ratio is always advancing in the correct direction. This assures that the vehicle will not experience ratio movement in the wrong direction due to reduction of ratio droop thus causing a feeling of back-driving torque that would be unacceptable to the driver or passengers.

The control systems and method described herein utilizing a dog clutch or interfacing clutch differs from that of a wet clutch as described in the previously mentioned U.S. Application No. 62/158,847, in that a wet clutch engages or disengages while transferring torque, allowing for much more flexibility in the mode shift logic and also the opportunity to make a shift without a torque interruption.

Referring now to FIG. 2, in one embodiment, a control system 100 is used with the transmission 1, for example. The control system 100 includes an input processing module 102 in communication with a transmission control module 104. The transmission control module 104 is in communication with an output processing module 106. The input processing module 102 is configured to read a number of sensors from the transmission 1, an engine, and/or vehicle (not shown). For example, the input processing module 102 reads signals from temperature sensors, pressure sensors, speed sensors, digital sensors such as range indicators or pressure switches, and CAN signals. In one embodiment, the transmission control module 104 optionally includes a number of modules to execute various aspects of control of the transmission 1. In some embodiments, the transmission control module 104 includes a variator ratio control module 108, a variator position control module 110, a clutch control module 112, and a mode-shift manager module 114. The variator ratio control module 108 is optionally configured to command a desired speed ratio for the variator 2, for example. The variator position control module 110 is optionally configured to command a desired carrier position for the variator 2, for example. The clutch control module 112 is optionally configured to command the position of the dog clutch 4, for example. In one embodiment, the mode-shift manager module 114 is configured to monitor the current operating condition of the transmission 1 and coordinate a shift from a first mode of operation to a second mode of operation, and/or vice versa. The output processing module 106 is configured to convert the values for commanded variables generated in the transmission control module 104 into voltage signals that are sent to corresponding actuators and/or solenoids in the transmission 1.

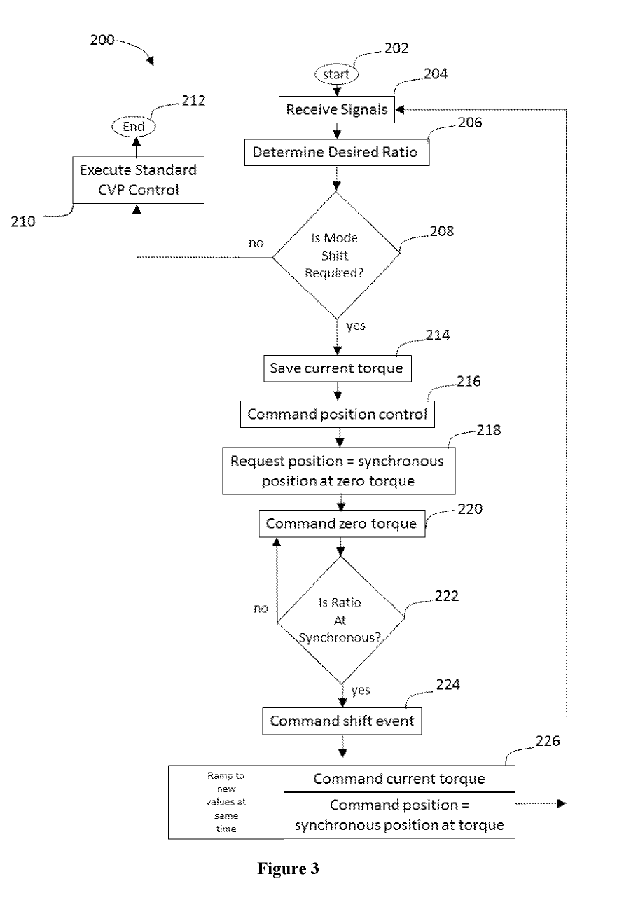

Referring now to FIG. 3, in one embodiment, the mode-shift manager module 114 optionally includes a control process 200. The control process 200 is optionally implemented during operation when an input power is in a positive direction and transitioning to a negative direction. The control process 200 begins at a start state 202 and proceeds to a state 204 where signals indicative of current operating torque, current variator speed ratio, current variator position, among others, are received. The control process 200 moves to a state 206 where a desired speed ratio for the transmission is determined. The control process 200 passes to a decision state 208 to evaluate if a change in operating mode, or clutch engagement, is required to achieve the desired speed ratio. If a mode shift is not required, the control process 200 proceeds to a state 210 where a command is sent to the transmission control module 104 to use the variator ratio control module 108 and then proceed to an end state 212. If a change in operating mode is required, the control process 200 proceeds to a state 214 where a process is implemented to save the current operating torque to memory. The control process 200 proceeds to a state 216 where a process is implemented to operate the transmission control module 104 in a position control mode. The control process 200 proceeds to a state 218 where a request is sent to the transmission control module 104 to command a position of the variator corresponding to the synchronous ratio at zero torque. The control process 200 moves to a state 220 where a zero torque command is sent. The control process 200 moves to a decision state 222 where the ratio is compared to the synchronous ratio. If the variator ratio is not equal to the synchronous point, the control process 200 proceeds back to the state 220. If the variator ratio is equal to the synchronous point, the control process 200 proceeds to a state 224 where a command is sent to the clutch control module 112 to command a shift event. The control process 200 proceeds to a state 226 where a command for current operating torque is sent to the transmission control module 104 in concert with a position command. The control process 200 proceeds to the state 210 where a command for variator speed ratio is determined before proceeding to the end state 212.

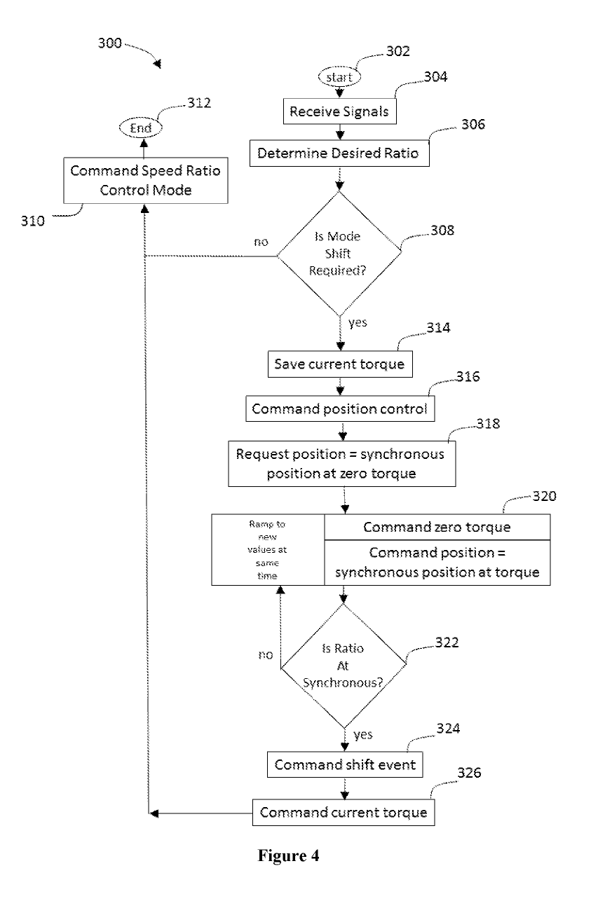

Moving now to FIG. 4, in one embodiment, the mode-shift manager module 114 optionally includes a control process 300. The control process 300 is optionally implemented during operation when an input power is in a negative direction and transitioning to a positive direction. The control process 300 begins at a start state 302 and proceeds to a state 304 where signals indicative of current operating torque, current variator speed ratio, current variator position, among others, are received. The control process 300 moves to a state 306 where a desired speed ratio for the transmission is determined. The control process 300 passes to a decision state 308 to evaluate if a change in operating mode, or clutch engagement, is required to achieve the desired speed ratio. If a mode shift is not required, the control process 300 proceeds to a state 310 where a command is sent to the transmission control module 104 to use the variator ratio control module 108 and then proceed to an end state 312. If a change in operating mode is required, the control process 300 proceeds to a state 314 where a process is implemented to save the current operating torque to memory. The control process 300 proceeds to a state 316 where a process is implemented to operate the transmission control module 104 in a position control mode. The control process 300 proceeds to a state 318 where a request is sent to the transmission control module 104 to command a position of the variator corresponding to the synchronous ratio at zero torque. The control process 300 proceeds to a state 320 where a command for current operating torque is sent to the transmission control module 104 in concert with a position command. The control process 300 moves to a decision state 322 where the ratio is compared to the synchronous ratio. If the variator ratio is not equal to the synchronous point, the control process 300 proceeds back to the state 320. If the variator ratio is equal to the synchronous point, the control process 300 proceeds to a state 324 where a command is sent to the clutch control module 112 to command a shift event. The control process 300 proceeds to a state 326 where a command is sent to resume current torque before proceeding to the state 310 and end state 312.

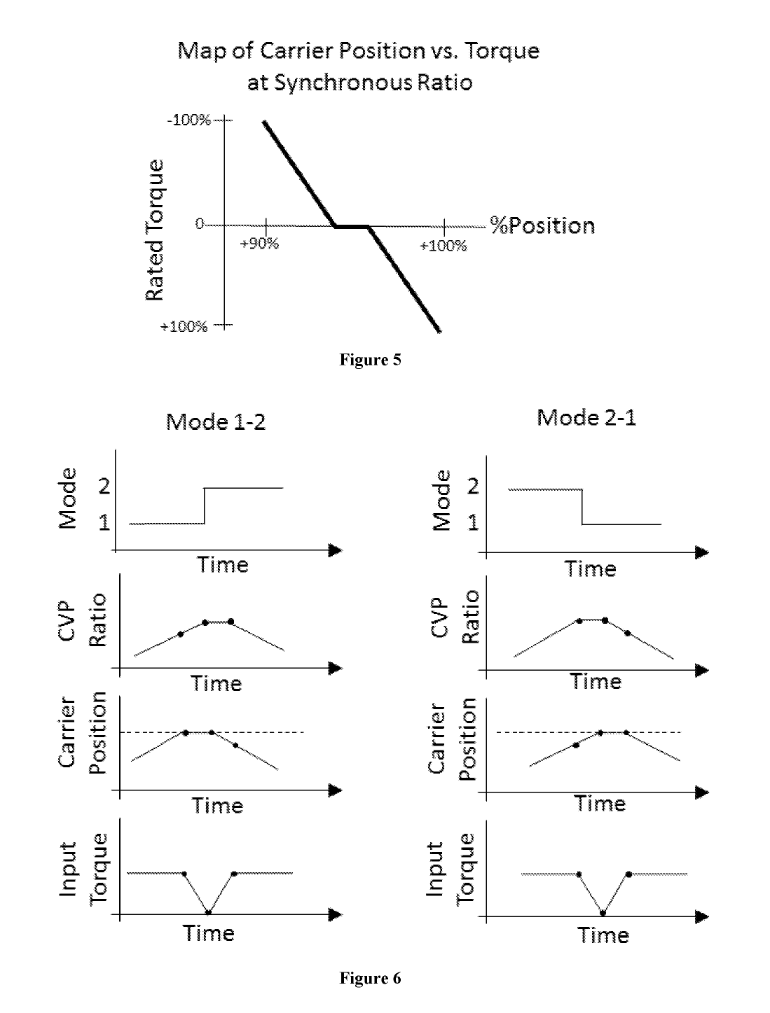

Referring now to FIG. 5, in one embodiment, the decision state 206 uses a stored calibration information for defining a relationship between operating torque and carrier position at a synchronous shift point. For example, the calibration information is depicted in a chart such as the one shown in FIG. 4. In some embodiments, the calibration information is implemented as a look-up table, a formula, or other means known in the art. Dog clutches, or interfacing clutches, often have a slight back taper on the teeth to assure that when torque is transferred across the clutch the taper draws the clutch into engagement to ensure that the clutch stays engaged. Because of this back taper, the clutches are very difficult to disengage when transferring torque due to the force required to overcome the engagement force produced by the back taper. Implementation of control process 200, 300 ensures that when at the synchronous ratio, the transmission is also at zero torque. This will allow for a shift that is fast and does not cause driveline disruptions (clunks, jerks, etc). Because the torque must reverse direction through the variator when shifting from one mode to the next, it must pass through zero torque. Control process 200, 300 command the carrier in the correct position to provide the synchronous ratio when torque reaches zero. The differences between the control process 200 and the control process 300 exists to assure that the ratio is always advancing in the correct direction. This assures that the vehicle will not experience ratio movement in the wrong direction due to reduction of ratio droop thus causing a feeling of back-driving torque that would be unacceptable to the driver or passengers. The control processes for implementing an interfacing clutch differs from that of a wet clutch in that a wet clutch is capable of engaging or disengaging while transferring torque, allowing for much more flexibility in the mode shift logic and also the opportunity to make a shift without a torque interruption.

Referring now to FIG. 6, during operation of the transmission 1, for example, a shift from a first mode of operation (“mode 1”) to a second mode of operation (“mode 2”) is depicted as shown in the charts of FIG. 6. As discussed previously in reference to FIG. 5, the control process 200, 300 moves the carrier position to a synchronous ratio under zero torque conditions.

Those of skill will recognize that the various illustrative logical blocks, modules, circuits, and algorithm steps described in connection with the embodiments disclosed herein, including with reference to the transmission control system described herein, for example, may be implemented as electronic hardware, software stored on a computer readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Software associated with such modules may reside in RAM memory, flash memory, ROM memory, EPROM memory, EEPROM memory, registers, a hard disk, a removable disk, a CD-ROM, or any other suitable form of storage medium known in the art. An exemplary storage medium is coupled to the processor such that the processor reads information from, and writes information to, the storage medium. In the alternative, the storage medium may be integral to the processor. The processor and the storage medium may reside in an ASIC. For example, in one embodiment, a controller for use of control of the IVT 1 comprises a processor (not shown).

It should be noted that the description above has provided dimensions for certain components or subassemblies. The mentioned dimensions, or ranges of dimensions, are provided in order to comply as best as possible with certain legal requirements, such as best mode. However, the scope of the inventions described herein are to be determined solely by the language of the claims, and consequently, none of the mentioned dimensions is to be considered limiting on the inventive embodiments, except in so far as any one claim makes a specified dimension, or range of thereof, a feature of the claim.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1-21. (canceled)

22. A control system for a multiple-mode continuously variable transmission comprising a ball planetary variator operably coupled to multiple-mode gearing, the control system comprising:
a plurality of sensors coupled to the ball planetary variator and the multiple-mode gearing, the sensors configured to provide a plurality of electronic signals;
a variator position control module configured to command a position of the ball planetary variator;
a clutch control module configured to control an interfacing clutch, wherein the interfacing clutch is operably coupled to the ball planetary variator and the multiple-mode gearing;
a variator ratio control module configured to command a ratio of the ball planetary variator;
a mode-shift manager module configured to be in communication with the clutch control module, the variator position control module, and the variator ratio control module;
wherein the mode-shift manager module is configured to coordinate a torque command, a variator ratio command, a variator position command, and a clutch command based at least in part on a synchronous shift point, and wherein the mode-shift manager module is configured to command a zero torque value based at least in part on a comparison of the variator position to the synchronous shift point.

23. The control system of claim 22, wherein the variator ratio control module, the variator position control module, the clutch control module and the mode-shift manager module are configured within a transmission control module.

24. The control system of claim 22, wherein the mode-shift manager module comprises at least one configurable table stored in memory, the configurable table containing a plurality of torque values corresponding to a variator position at a synchronous shift point.

25. The control system of claim 22, wherein the mode-shift manager module is configured to communicate with the clutch control module, and the mode-shift manager is adapted to send a command for a shift event based at least in part on a comparison to a variator position corresponding to the synchronous shift point.

26. The control system of claim 22, wherein the mode-shift manager module is configured coordinate a shift from an initial mode of operation to a next mode of operation, and/or vice versa.

27. The control system of claim 22, wherein the clutch control module is configured to command position of the interfacing clutch.

28. The control system of claim 22, wherein the variator ratio control module is configured to command a desired speed ratio for the variator.

29. The control system of claim 22, wherein the variator position control module is configured to command a desired carrier position for the variator.

30. The control system of claim 22 further comprising:
an input processing module configured to read a number of sensors from the multiple-mode continuously variable transmission, an engine, and/or a vehicle.

31. The control system of claim 30, wherein the input processing module is configured to read the plurality of signals from the plurality of sensors, the plurality of signals comprising; temperature sensors, pressure sensors, speed sensors, and digital sensors comprising range indicators, pressure switches and CAN signals.

32. The control system of claim 23, wherein an output processing module is configured to convert the values for commanded variables generated in the transmission control module into voltage signals that are sent to corresponding actuators and/or solenoids in the transmission.

33. A method of operating a multiple-mode continuously variable transmission comprising a variator, a multiple-mode gearing, and an interfacing clutch, the method comprising the steps of:
receiving a plurality of input signals indicative of a variator position, a variator ratio, and a transmission operating torque;
comparing a current variator ratio to a synchronous shift variator ratio corresponding to a synchronous shift point of the multiple-mode continuously variable transmission;
commanding a zero input torque based at least in part on said comparison;
commanding a shift of the interfacing clutch based at least in part on said comparison; and
commanding a variator position based at least in part on said comparison.

34. A method of operating a multiple-mode continuously variable transmission comprising a variator, a multiple-mode gearing, and an interfacing clutch, the method comprising the steps of:
receiving a plurality of input signals indicative of a variator position, a variator ratio, and a transmission operating torque;
commanding a zero input torque based at least in part on a synchronous shift point of the multiple-mode continuously variable transmission;
commanding a variator position based at least on the zero input torque;
comparing a current variator ratio to the synchronous shift variator ratio corresponding to the synchronous shift point; and
commanding a shift of the interfacing clutch based at least in part on said comparison.
